(19) United States
(12) Patent Application Publication
(10) Pub. No.: US 2012/0286693 A1
(43) Pub. Date: Nov. 15, 2012

(54) Circuit Assembly and Method for Operating a Discharge Lamp

(76) Inventors: Alois Braun, Neuburg (DE); Walter Limmer, Munchen (DE); Maximilian Schmidl, Pullach (DE)

(21) Appl. No.: 13/512,014

(22) PCT Filed: Nov. 15, 2010
(86) PCT No.: PCT/EP2010/067449

§ 371 Date: May 24, 2012

(30) Foreign Application Priority Data
Nov. 24, 2009 (DE) 102009054377.5

(51) Int. Cl. H05B 41/24

(52) U.S. Cl. 315/283

(57) ABSTRACT

A circuit assembly for operating a discharge lamp (5) comprising a full-bridge assembly (1), which supplies the discharge lamp (5), wherein the circuit assembly can operate the discharge lamp (5) at a low-frequency and at a high-frequency voltage, and the circuit assembly is configured: to operate the discharge lamp (5) directly after starting the lamp at a high-frequency voltage, and to operate the discharge lamp (5) above a predetermined lamp voltage (U_{T}) at a low-frequency voltage, wherein the full-bridge assembly (1) always operates in discontinuous conduction mode.

### TECHNICAL FIELD

The invention relates to a circuit assembly and a method for operating a discharge lamp, wherein the circuit assembly can operate the discharge lamp at a low-frequency and a high-frequency voltage.

### BACKGROUND

The invention relates to a circuit assembly and a method for operating a discharge lamp according to the preamble of the main claim.

Conventional circuit assemblies for operating discharge lamps apply an optimized power to the discharge lamp, hereinafter also called the lamp, shortly after starting the lamp in order to heat it up quickly and to reach the steady burning state without prior damage. This problem relates primarily, but not solely, to high-pressure discharge lamps, which, when operated at nominal power, often take several minutes to achieve a stable burning state. In this context, stable burning state means the operating state in which the discharge vessel of the discharge lamp has a uniform temperature when operated at nominal power.

In particular, high-pressure discharge lamps are preferably operated at a low-frequency rectangular lamp current in order to avoid the problem of acoustic resonances in the burner vessel, hereinafter also called the burner, at higher frequencies. Frequently, the gas discharge lamp is supplied by a full-bridge assembly, which simultaneously functions as a step-down voltage converter in order to reduce the higher DC supply voltage to the lamp voltage. To this end, a half-bridge arrangement of the full bridge operates at a higher-frequency, generally pulse-width modulated, signal with which the low-frequency rectangular signal is modulated. This signal works together with a step-down inductor and a filter capacitance comprising at least one capacitor in order to reduce the voltage. Since, shortly after ignition, the current applied to the lamp should be as constant as possible in order to ensure rapid run-up, during this time, the step-down voltage converter in the full bridge should operate in continuous conduction mode. Therefore, the current applied to the lamp normally lies within a range specified for this type of lamp. In continuous conduction mode, the step-down inductor is not completely discharged in one cycle. This means that no ZVS (zero voltage switching) is possible here and higher switching losses occur here. However, continuous conduction mode is necessary since otherwise the low lamp voltage in this phase would cause the working frequency to drop below 20 kHz and, at a frequency of more than 20 kHz the required current cannot be applied to the high-pressure discharge lamp. However, a working frequency of less than 20 kHz is not possible due to the human auditory threshold. Only as the burner temperature increases does the lamp voltage increase and the step-down voltage converter can then be run in the more efficient discontinuous conduction mode.

In another conventional circuit assembly, which is shown in FIG. 1, the discharge lamp is started with a resonant ignition. The circuit assembly has a voltage converter (not shown here), which converts mains voltage into a DC supply voltage U₀, and a full-bridge assembly 1 with half-bridge midpoints 2, 3 connected by a series connection of two inductors L1, L2 and the gas discharge lamp 5. Two capacitors C1, C2 are connected at the interconnection point between the first inductor L1 and the gas discharge lamp 5, the first capacitor C1 to the positive supply voltage 7, the second capacitor C2 to the switching ground 8. A third capacitor C3 is connected at the interconnection point between the second inductor L2 and the gas discharge lamp 5 after the switching ground 8. In order now to start the gas discharge lamp and to run up to nominal power, a three-stage method is performed with this conventional circuit assembly.

In the first step, the gas discharge lamp is started with a high-frequency high voltage generated by a resonance step-up. To this end, the switches Q1, Q2 of the first half bridge 11 remain open and the switches Q3, Q4 of the second half bridge 12 are actuated by a high-frequency signal. In this case, the excitation frequency is matched to the resonant frequency of the resonant circuit 13 comprising the second inductor L2 and the third capacitor C3. This high-frequency high voltage starts the lamp. The high-frequency voltage generated by the resonance is applied to the discharge lamp even after the lamp is started for a predetermined time, usually about 1 s, in order to bring the discharge lamp into a stable burning state quickly. After the expiry of this time, in the second step, a low-frequency rectangular mode is then used, in which the step-down voltage converter of the full-bridge assembly operates in discontinuous conduction mode in order to apply the required current to the lamp. Only after some time, when the temperature of the burner and hence the lamp voltage U_{L} is sufficiently high, is the step-down voltage converter switched to the energy-efficient discontinuous conduction mode in a third step.

However, in order to be able to use continuous conduction mode, the components of the circuit assembly or the full-bridge assembly 1 must have substantially larger dimensions because the stresses are much higher in this mode. This is all the more disadvantageous since this operating mode is only run for a short time after starting the lamp. This means that a circuit assembly with components which are too large, too heavy and hence too expensive for the majority of the operating time is only actually required for diminishingly small fraction of the overall operating period.

### OBJECT

A circuit assembly and a method for operating a discharge lamp are provided, wherein the circuit assembly can operate the discharge lamp at a low-frequency and a high-frequency voltage and the components of the circuit assembly can be dimensioned for steady-state operation.

### SUMMARY

A circuit assembly for operating a discharge lamp is provided, comprising a full-bridge assembly which supplies the discharge lamp, wherein the circuit assembly can operate the discharge lamp at a low-frequency and high-frequency voltage and the circuit assembly is designed:
to operate the discharge lamp (for example, (directly) after starting the lamp) at a high-frequency voltage and
to operate the discharge lamp above a predetermined lamp voltage at a low-frequency voltage, wherein the full-bridge assembly in this case (for example, always) always operates in discontinuous conduction mode. This enables the components of the entire circuit assembly to be dimensioned for a discontinuous conduction mode and hence to be small and inexpensive.

Also provided is a method for operating a discharge lamp with a circuit assembly comprising a full-bridge assembly for supplying the discharge lamp, wherein the circuit assembly can operate the discharge lamp at a low-frequency and a high-frequency voltage and:
the discharge lamp (for example, (directly) after starting the lamp) is operated at a high-frequency voltage and
the discharge lamp is operated above a predetermined lamp voltage at a low-frequency voltage, wherein the full-bridge assembly in this case (for example, always) operates in discontinuous conduction mode.

During the run-up shortly after starting, the discharge lamp (5) is operated with a lamp current I_{L}. In this case, for example, the following relationship applies for the lamp current during run-up: 1.0*I_{Nom}<I_{L}<2.0*I_{Nom}, wherein I_{Nom} is the lamp current in nominal operation, that is in steady state at nominal power of the gas discharge lamp. In other words, this means that the circuit assembly is set up, for example, in such a way that the lamp current is provided according to the above requirement. For example, the following relationship can be specified for the lamp current I_{L} during run-up: 1.3*I_{Nom}<I_{L}<1.8*I_{Nom}. If the lamp current is maintained in this range, a more reliable and quicker run-up of the gas discharge lamp is ensured without the electrodes of the gas discharge lamp being thermally overloaded and hence damaged. Switching from the high-frequency mode to the low-frequency discontinuous conduction mode can in this case can take place at the earliest on the achievement of a predetermined lamp voltage U_{LV}. The predetermined lamp voltage U can in this case be calculated from the following relationship:

$${U}_{Lv} = \frac{{I}_{L} \cdot 2 \cdot {L}_{1} \cdot {f}_{min}}{1 - D}$$

where L1 is the step-down inductor of the full-bridge assembly, D is the duty factor of the full-bridge assembly in step-down mode and fₘᵢₙ is the minimum frequency of the step-down mode.

To this end, the circuit assembly can be designed to measure the lamp voltage (for example, directly) in high-frequency mode. This has the advantage of a simpler control system. However, the lamp voltage is more difficult to measure and this means, at a justifiable cost, the measurement remains comparatively imprecise. A more precise measurement is possible if the circuit assembly is designed to measure the lamp voltage in a (for example, short) periodic low-frequency phase, which is inserted the in the high-frequency phase. However, this requires a more complex control system. However, with present-day digitally controlled circuit assemblies, this can be achieved purely by means of software and can be implemented in a cost-neutral or very inexpensive way.

### BRIEF DESCRIPTION OF THE DRAWING(S)

Further advantages, features and details of the invention may be obtained with reference to the following description of exemplary embodiments and with reference to the drawings in which identical elements or elements with identical functions are given identical reference characters. The drawings show:

FIG. 1 a full-bridge assembly, which starts a discharge lamp with a resonant ignition and is able to control the lamp power with a step-down voltage converter,

FIG. 2 a schematic diagram of the operating modes of the full-bridge assembly in dependence on the lamp voltage,

FIG. 3 a lamp voltage diagram over time for an embodiment with a special lamp voltage measurement.

### PREFERRED EMBODIMENT OF THE INVENTION

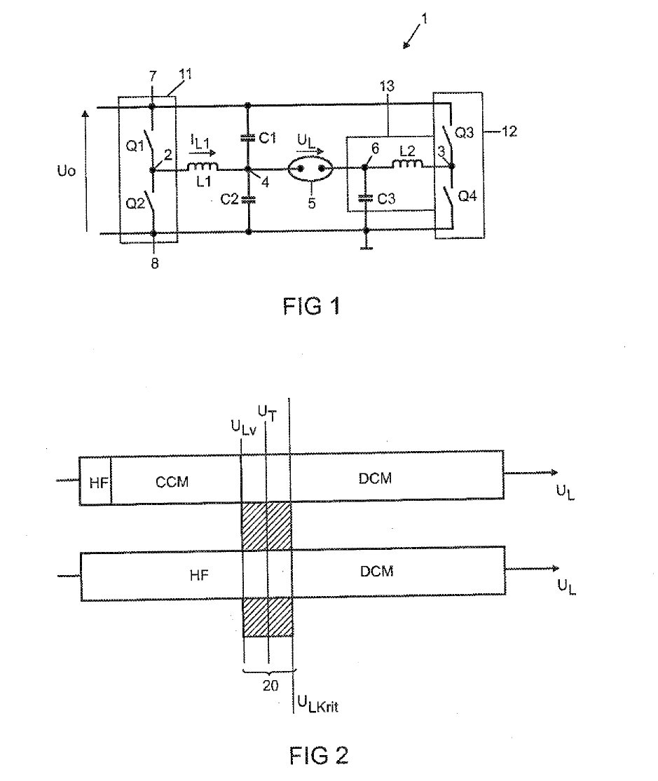

FIG. 1 shows the circuit assembly described in the introduction with the basic topology also used for conventional devices. A circuit assembly in this topology is designed for resonant ignition.

As mentioned in the introduction, a second half bridge 12 is used to apply a high-frequency voltage to a gas discharge lamp 5, while switches Q1, Q2 of an also provided first half bridge 11 remain open. The resonant circuit 13, comprising or consisting of a second inductor L2 and a third capacitor C3, is used in this case to increase the voltage, which can be set by means of the excitation frequency. In this mode of operation, a first capacitor C1 and a second capacitor C2 function as half-bridge return capacitors, which close the circuit through the lamp 5. The gas discharge lamp 5 is arranged between the resonant circuit 13 and the half-bridge return capacitors C1, C2. A suitable frequency adjustment of the second half bridge 12 causes the resonant circuit 13 to be strongly excited until an electric breakdown takes place in the gas discharge lamp 5. As soon as a discharge arc is established in the burner, the frequency regulation of the second half bridge 12 is operated in such a way that a predetermined current I_{L} through the gas discharge lamp 5 is set. The lamp run-up, that is the time until the gas discharge lamp 5 has reached its operating temperature and is operated at its nominal power P_{Nom} or its nominal current I_{Nom}, is subject to the following restrictions in order not to overload the gas discharge lamp 5 and to organize the lamp operation to be as noise-free as possible for humans:
the lamp current should, for example, fluctuate within the following range: 1.0*I_{Nom}<I_{L}<2.0*I_{Nom}, for example in the following range: 1.3*I_{Nom}<I_{L}<1.8*I_{Nom}.
in this case, the lamp power P_{L} of the gas discharge lamp 5 should be less than or at the most equal to the nominal power P_{Nom}: P_{L}<=P_{Nom}.
in order to ensure that the lamp operation is as quiet as possible for humans, the minimum frequency at which the second half bridge 12 is operated should lie outside the human hearing range, e.g. fₘᵢₙ>20 kHz. In the present embodiment of the circuit assembly according to the invention, the mean operating frequency of the second half bridge 12 is approximately 65 kHz, the minimum operating frequency is approximately 25 kHz.

With usual switching topologies, the DC supply voltage U₀ is an intermediate circuit voltage, which is regulated by an upstream voltage converter or an upstream power factor correction circuit to a constant voltage level. In a preferred embodiment, the DC supply voltage U₀ is regulated to 400V. Hence, a step-down inductor layout of L1=1.5 mH can service a voltage range of 10V-150V with a current range of 0 A-0.4 A.

The gas discharge lamp 5 is therefore started at a high-frequency resonant ignition and, after the electric breakdown, initially operated at a high-frequency lamp current. This mode of operation is maintained as long as possible. The time at which it is necessary to switch to a low-frequency rectangular mode depends upon the lamp voltage.

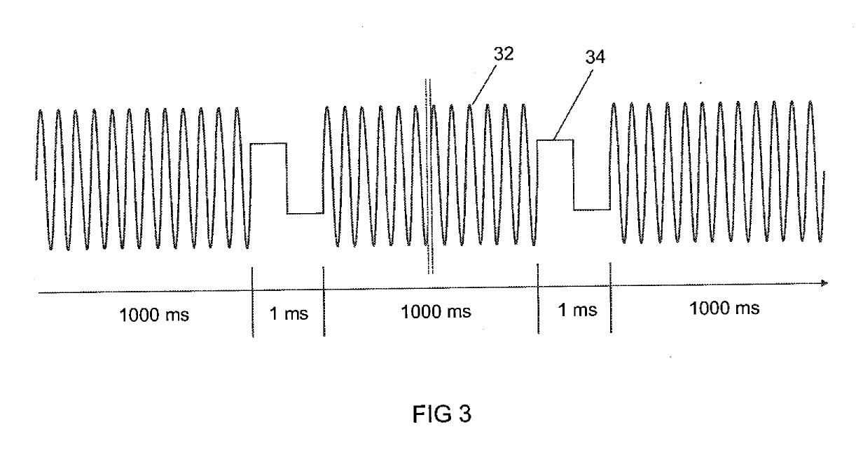

FIG. 2 shows a schematic diagram of the operating modes of the full-bridge assembly in dependence on the lamp voltage. The top diagram shows the operating modes of the conventional circuit assemblies and the bottom diagram shows the operating modes for the circuit assembly according to one embodiment. This drawing also shows a switching range 20, in which it is possible, and also advisable, for a change of operating modes to take place as far as the lamp is concerned. The switching range starts at a predetermined lower lamp voltage U_{Lv} and ends at a predetermined upper lamp voltage U_{Lcrit}. The switchover takes place at the lamp voltage U_{T}, which lies between the predetermined lower lamp voltage U_{Lv} and the predetermined upper lamp voltage U_{Lcrit}.

In the top diagram, which shows the conventional method for the circuit assemblies described in the introduction, the run-up of the gas discharge lamp 5 is effected after starting the lamp in continuous conduction mode (CCM) and, at the switchover time at the predetermined lower lamp voltage U_{Lv}, switchover to discontinuous conduction mode (DCM) takes place. Here, as already mentioned in the introduction, the high-frequency mode HF is only used for. the ignition and, shortly after the establishment of a discharge arc, switchover to the low-frequency rectangular mode in the continuous conduction operating mode CCM takes place.

The bottom diagram shows an operating method according to different exemplary embodiments as implemented by the circuit assembly according to different exemplary embodiments. Here, the high-frequency operating mode HF is maintained as long as possible. Here, the high-frequency operating mode HF can only be maintained up to the predetermined upper lamp voltage U_{Lcrit}, since, from this predetermined upper lamp voltage U_{Lcrit} (the lamp voltage correlates directly with the temperature of the gas discharge lamp burner), acoustic resonances could occur in the gas discharge lamp burner, which cause flickering and in the worst case could result in the quenching of the gas discharge lamp. As already mentioned, the lamp voltage is directly dependent on the pressure in the discharge vessel of the gas discharge lamp burner. The higher the pressure in the gas discharge lamp burner, the higher the contraction of the discharge arc. The more contracted the discharge arc, the more susceptible it is with respect to acoustic resonances in the gas discharge lamp burner. Therefore, susceptibility to acoustic resonances is directly dependent upon the pressure in the gas discharge lamp burner and hence also directly dependent on the operating voltage of the gas discharge lamp. This results in a limit in the form of the predetermined upper lamp voltage U_{Lcrit} from which a high-frequency mode of the gas discharge lamp becomes critical. Depending upon the type of lamp, the predetermined upper lamp voltage U_{Lcrit} can be between 20V and 60V; with common types of lamp this fluctuates in range between 30V and 50V. This applies, for example, to common high-pressure discharge lamps with nominal powers of 20W, 35W, 70W and 150W. The precise voltage depends on the type of lamp and the geometry. Quartz glass lamps will have predetermined upper lamp voltages U_{Lcrit} different to those of ceramic lamps.

As from the predetermined lower lamp voltage U_{Lv} it is possible to switch to the low-frequency rectangular mode in discontinuous conduction mode. The predetermined lower lamp voltage U_{Lv}, as from which a low-frequency discontinuous mode is possible, can be calculated from the following relationship:

$${U}_{Lv} = \frac{{I}_{L} \cdot 2 \cdot {L}_{1} \cdot {f}_{min}}{1 - D} .$$

Here, D is the duty factor of the full-bridge assembly in step-down mode and can also be described by the quotient of lamp voltage U_{L} and DC supply voltage U₀: D=U_{L}/U₀. If a switchover from high-frequency mode to step-down low-frequency rectangular mode is made at a lamp voltage between the predetermined lower lamp voltage ULv and the predetermined upper lamp voltage U_{Lcrit}, the full bridge can be operated directly in discontinuous conduction mode. This mode of operation according to the invention enables a completely different dimensioning of the components in question. The components can have substantially smaller dimensions and need a less robust design, which saves costs and enables miniaturization. This enables the circuit assembly according to various exemplary embodiments to be much smaller than known conventional circuit assemblies.

In order to be able to determine the switchover time, the circuit assembly should be aware of the current lamp voltage. For example, there are two possibilities for the circuit assembly according to the invention according to different exemplary embodiments: a first possibility consists in measuring the lamp voltage in high-frequency mode. However, this requires very expensive measuring elements which should be matched to the operating frequency.

A second possibility for lamp voltage measurement is shown in FIG. 3. This figure shows a lamp voltage diagram over time for measuring the lamp voltage in the DC voltage mode. To this end, a switchover from the high-frequency mode 32 for a very short time of, for example, a few ms to a low-frequency rectangular mode with a DC voltage phase 34 takes place at regular intervals, e.g. every second. During this time, a lamp voltage measurement is performed in order thereafter to switch back to the high-frequency mode 32. The lamp voltage measurement during the DC voltage phase 34 has the advantage of a simpler and more precise measurement, since the voltage can be picked up directly via simple measuring elements. During the short DC voltage phases 34, the full bridge has to be switched to continuous conduction mode. However, since at 1 ms, this phase is very short, this mode of operation is also possible with the ‘small’ dimensions of the components used for the discontinuous conduction mode. As is clearly shown in this diagram, a whole full wave is always completed in the DC voltage phase 34. This occurs in order to load the electrodes of the gas discharge lamp 5 uniformly.

1. A circuit assembly for operating a discharge lamp comprising a full-bridge assembly, which supplies the discharge lamp, wherein the circuit assembly can operate the discharge lamp at a low-frequency and at a high-frequency voltage, and the circuit assembly is configured:
to operate the discharge lamp directly after starting the lamp at a high-frequency voltage, and
to operate the discharge lamp above a predetermined lamp voltage at a low-frequency voltage, wherein the full-bridge assembly always operates in discontinuous conduction mode.

2. The circuit assembly as claimed in claim 1, wherein the circuit assembly is configured such that the following relationship applies for a lamp current I_{L} during run-up: 1.0*I_{Nom}<I_{L}<2.0*I_{Nom}, where I_{Nom} is the lamp current in nominal operation, i.e. in steady state operation at nominal power of the gas discharge lamp.

3. The circuit assembly as claimed in claim 2, wherein the circuit assembly is configured such that the following relationship applies for the lamp current I_{L} during run-up: 1.3*I_{Nom}<I_{L}<1.8*I_{Nom}.

4. The circuit assembly as claimed in claim 1, wherein the predetermined lamp voltage lies between a predetermined lower lamp voltage and a predetermined upper lamp voltage.

5. The circuit assembly as claimed in claim 4, wherein the circuit assembly is configured to calculate the predetermined lower lamp voltage U_{Lv} according to the following relationship:
$${U}_{Lv} = \frac{{I}_{L} \cdot 2 \cdot {L}_{1} \cdot {f}_{min}}{1 - D} ,$$
where L₁ is the step-down inductor of the full-bridge assembly, D is the duty factor of the full-bridge assembly in step-down mode and fₘᵢₙ is the minimum frequency of the step-down mode.

6. The circuit assembly as claimed in claim 4, wherein the predetermined upper lamp voltage is between 20V and 60V.

7. The circuit assembly as claimed in claim 1, wherein the circuit assembly is configured to measure the lamp voltage directly in high-frequency mode.

8. The circuit assembly as claimed in claim 1, wherein the circuit assembly is configured to measure the lamp voltage in a short periodic low-frequency phase, which is inserted into the high-frequency phase.

9. A method for operating a discharge lamp with a circuit assembly comprising a full-bridge assembly for supplying a discharge lamp, wherein the circuit assembly can operate the discharge lamp at a low-frequency and a high-frequency voltage, and
the discharge lamp is operated directly after starting the lamp at a high-frequency voltage and
the discharge lamp is operated above a predetermined lamp voltage at a low-frequency voltage,
wherein the full-bridge assembly always operates in discontinuous conduction mode.

10. The method as claimed in claim 9, wherein the predetermined lamp voltage lies between a predetermined lower lamp voltage and a predetermined upper lamp voltage.

11. The method as claimed in claim 9, wherein the predetermined lower lamp voltage U_{Lv} can be calculated by the following relationship:
$${U}_{Lv} = \frac{{I}_{L} \cdot 2 \cdot {L}_{1} \cdot {f}_{min}}{1 - D} ,$$
where L₁ is the step-down inductor of the full-bridge assembly, D is the duty factor of the full-bridge assembly in step-down mode and fₘᵢₙ is the minimum frequency of the step-down mode.

12. The method as claimed in claim 9, wherein the predetermined upper lamp voltage is between 20V and 60V.

13. The method as claimed in claim 9, wherein the predetermined upper lamp voltage is between 30V and 50V.

14. The circuit assembly as claimed in claim 4, wherein the predetermined upper lamp voltage is between 30V and 50V.
